(19) United States
(12) Patent Application Publication
(10) Pub. No.: US 2012/0003969 A1
(43) Pub. Date: Jan. 5, 2012

(54) METHOD AND APPARATUS FOR ESTABLISHING A GROUP CALL

(75) Inventors: Henry W. Anderson, Palatine, IL (US); Jeff S. Anderson, Itasca, IL (US); Bradley M. Hiben, Glen Ellyn, IL (US)

(73) Assignee: MOTOROLA, INC., SCHAUMBURG, IL (US)

(21) Appl. No.: 12/826,928

(22) Filed: Jun. 30, 2010

(51) Int. Cl. H04M 3/42

(52) U.S. Cl. 455/414.2; 455/416

(57) ABSTRACT

A method, device, and system for establishing a group call among a plurality of communication devices. The method includes initiating a group call among at least some of the plurality of communication devices, wherein each communication device uses a unicast communication link to participate in the group call. The method further includes computing one or more broadcast or multicast parameters during the group call, identifying a subset of communication devices based on the broadcast or multicast parameters, and switching the identified subset of communications devices to a broadcast or multicast communication link during the group call.

### RELATED APPLICATIONS

The present application is related to the following U.S. application commonly owned with this application by Motorola, Inc.: Ser. No. ______, filed Jun. 30, 2010, titled “METHOD AND APPARATUS FOR ESTABLISHING AND MAINTAINING A SPECTRALLY EFFICIENT MULTICAST GROUP CALL” (attorney docket no. CM13342), the entire contents of which being incorporated herein by reference.

### FIELD OF THE DISCLOSURE

The present disclosure relates generally to group calls in communication systems and more particularly to a method and apparatus for establishing a group call in a communication system.

### BACKGROUND

Various real time situations require a group call setup in a communication system to enable users in different geographical locations having varying signal conditions to communicate at the same time. One method to quickly setup a group call is by using unicast bearers i.e. each user will have an uplink and a downlink logical channel pair for participating in the group call. In a Long Term Evolution (LTE) system the typical initial setup time for a unicast call ranges from one hundred to five hundred milli seconds (100-500 msecs). However, using an uplink and a downlink logical channel pair for each user in the group call consumes a lot of frequency spectrum.

An alternative method for setting up a group call is by using broadcast or multicast bearers for users within a preconfigured broadcast or multicast region such as multimedia broadcast over single frequency network (MBSFN) area. In this method each user will have individual uplink channels and a common downlink channel, thereby reducing the number of communication links used for the group call. However, the approximate call setup time in this case is typically around one to five seconds (1-5 secs). In other words, although the alternative method increases the spectral efficiency of the communication system, the method has an increased initial call setup time. Further, the alternative method describes group call setup based on preconfigured regions and does not describe continuing the group call when the users move from one place to another.

Accordingly, there is a need for a method and apparatus for establishing a group call.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system in accordance with some embodiments.

FIG. 2 is a block diagram illustrating an embodiment of a communication device employed in the communication system of FIG. 1.

FIG. 3 is a high level flow diagram illustrating a method for establishing a group call among a plurality of communication devices in a communication system in accordance with some embodiments.

FIG. 4 is a more detailed flow diagram illustrating a method for establishing a group call among a plurality of communication devices in a communication system in accordance with some embodiments.

FIG. 5 is a signal flow diagram describing the flow of signals between different devices for establishing a group call among a plurality of communication devices in a communication system in accordance with some embodiments

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method, device, and system for quickly establishing a group call among a plurality of communication devices by using unicast bearer services and then switching the group call to multicast bearer services after the system has instantiated the multicast services is described herein.

In accordance with one embodiment, a method, device, and system for establishing a group call among a plurality of communication devices is described herein. The system includes a plurality of communication devices serviced by their respective base stations and a control entity for communicating with the base stations. The system further includes at least some of the plurality of communication devices participating in the group call using unicast communication links. In accordance with some embodiments, the control entity computes one or more broadcast or multicast parameters during the group call, identifies a subset of communication devices based on the broadcast or multicast parameters, and switches the identified subset of communications devices to a broadcast or multicast communication link during the group call.

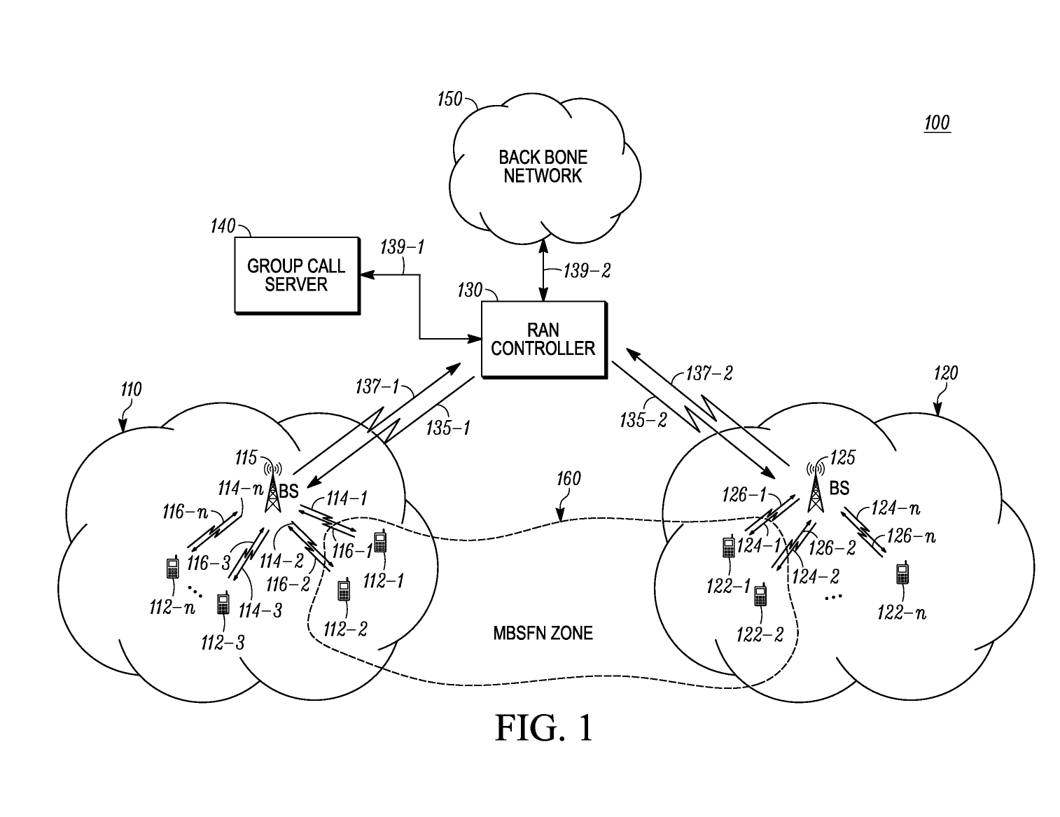

Referring now to figures, FIG. 1 is a block diagram of a communication system 100 for establishing and maintaining a group call. In accordance with some embodiments the communication system 100 is a Long Term Evolution/Evolved Universal Terrestrial Radio Access (LTE/EUTRA) system. However, the teachings herein are not limited to LTE/EUTRA system but can be applied to other type of systems using the same or different multiplexing technologies. Such systems may include, for example, Institute of Electrical and Electronics Engineers (IEEE) 802.16/Worldwide Interoperability for Microwave Access (WiMax), Universal Mobile Telecommunications System (UMTS), Code Division Multiple Access (CDMA) 2000, IEEE 802.11, and the like.

Referring to FIG. 1, the communication system 100 includes a radio access network (RAN) controller 130 communicatively coupled to a group call server 140 and a back bone network 150 such as, but not limited to an internet. The RAN controller 130 can access all information needed for a group call from the group call server 140. The group call server 140 can include a database containing a list of identities such as phone number, IP address, etc, associated with the communication devices that are participating in the group call. The group call server 140 can be a separate device from the RAN controller 130 or the functionality of the group call server 140 can be incorporated in the RAN controller 130. The communication system 100 further includes multiple enhanced NodeBs (eNodeBs) 115 and 125 serving, respectively, a plurality of coverage areas 110 and 120, also referred to as sites or cellular sites.

As used herein, eNodeBs 115 and 125 are infrastructure devices that can communicate information in a wireless signal with the RAN controller 130 using a logical channel pair comprising an uplink or reverse 137-1 and 137-2 logical channel and downlink or forward 135-1 and 135-2 logical channel, respectively. The eNodeBs 115 and 125 can also receive information from one or more UEs 112-1, 112-2 . . . 112-n and 122-1, 122-2 . . . 122-n via logical uplink channels 116-1 . . . 116-n and 126-1 . . . 126-n, respectively. Further, the eNodeBs 115 and 125 can transmit information to one or more UEs 112-1, 112-2 . . . 112-n and 122-1, 122-2 . . . 122-n via logical downlink channels 114-1 . . . 114-n and 124-1 . . . 124-n, respectively. An eNodeB 115, 125 includes, but is not limited to, equipment commonly referred to as base transceiver stations, access points, routers or any other type of UE interfacing device in a wireless environment.

Returning to FIG. 1, each coverage area 110 and 120 includes a plurality of communication devices 112-1, 112-2 . . . 112-n and 122-1, 122-2 . . . 122-n also called as user equipments (UEs) or subscriber stations serviced by their respective eNodeBs 115 and 125. As referred to herein, an UE 112-1 . . . 112-n, 122-1 . . . 122-n includes, but is not limited to, devices commonly referred to wireless communication devices such as mobile radios, mobile stations, subscriber units, access terminals, mobile devices, or any other device capable of operating in a wireless environment. Examples of UE include, but are not limited to, two-way radios, mobile phones, cellular phones, Personal Digital Assistants (PDAs), laptops and pagers.

In FIG. 1, the RAN controller 130, the eNodeBs 115 and 125, and the UEs 112-1, 112-2 . . . 112-n and 122-1, 122-2 . . . 122-n are equipped with transceivers, memories, and processing devices operatively coupled to carry out their functionality, including any functionality needed to implement the teachings herein and are further equipped with any other elements needed in a commercial embodiment. Further, only a single RAN controller and two cellular sites are shown for ease of illustration. However, the teachings herein can be implemented within a system comprising additional RAN controller and more or fewer sites.

Referring back to FIG. 1, in accordance with some embodiments, at least one of the plurality of UEs 112-1, 112-2 . . . 112-n, 122-1, 122-2 . . . 122-n sends a group call initiation request to at least one of eNodeBs 115 or 125, for establishing a group call. A group call is defined as a communication mode where a calling party or a group call initiator wishes to involve a plurality of other parties or devices in a particular communication, for example, voice communication, data communication, etc. Upon receiving the group call initiation request, the eNodeB 115 or 125 establishes the group call by using unicast communication links between itself and each participating UE. During the group call, the eNodeB 115,125 receives a set of link and location parameters associated with the participating UEs and forwards the same to the RAN controller 130 and/or the group call server 140. The RAN controller 130 or the group call server 140 computes one or more broadcast or multicast parameters, identifies a subset of UEs based on the broadcast or multicast parameters, and switches the identified subset to a broadcast or multicast communication link.

Only a limited number of eNodeBs 115, 125 and UEs 112-1, 112-2 . . . 112-n, 122-1, 122-2 . . . 122-n are shown for ease of illustration. However, the communication system 100 can include any number of eNodeBs to support any number of UEs based on system requirements. Moreover, embodiments are not dependent on the protocol(s) used to facilitate communications in the system and can be used with any such protocols.

In general, the communication links (also referred to herein as communication channels or channels) comprise the physical communication resources over which information is sent between different elements in the communication system 100 and can include wired links (e.g., links 139-1 and 139-2) or wireless links (e.g., 135-1, 135-2, 137-1, 137-2, 114-1 . . . 114-n, 116-1 . . . 116-n,124-1 . . . 124-n, and 126-1 . . . 126-n) with a wireless interface between the equipment in the communication system 100 being defined by the protocols implemented in the communication system 100. For example, as illustrated in FIG. 1, the eNodeB 115, 125 forwards information such as group call initiation request, link and location parameters associated with the UEs, etc, to the RAN controller 130 via an uplink 137-1,137-2. The eNodeB 115, 125 receives control information such as switching some of the communication devices to a multicast or broadcast link, etc, from the RAN controller 130 via a downlink 135-1, 135-2. Further, the eNodeB 115, 125 receives group call initiation request from one or more UEs 112-1, 112-2 . . . 112-n, 122-1, 122-2 . . . 122-n via respective logical uplink channels 116-1 . . . 116-n, 126-1 . . . 126-n. The eNodeB 115, 125 can unicast, broadcast, or multicast information to one or more UEs 112-1, 112-2 . . . 112-n, 122-1, 122-2 . . . 122-n via respective logical downlink channels 114-1 . . . 114-n, 124-1 . . . 124-n.

In a LTE/EUTRA system, each logical channel pair (uplink and downlink pair), e.g., 114-116 and 124-126 constitutes frequency division duplexed (FDD) or time division duplexed (TDD) physical layer channels (frequency channels). The downlink or forward channel includes physical layer channels transmitted from the LTE/EUTRA to the user equipments, wherein the forward channel is also capable of supporting broadcast and multicast of control information and media information such as but not limited to audio media, video media, data media, and multimedia. The uplink or reverse channel includes the physical layer channels transmitted from the user equipments to the LTE/EUTRA.

The embodiments are described in the context of an LTE/EUTRA system for ease of illustration. However, the embodiments are not limited to such a system but can be applied within any other system that employs multiple carrier frequencies for multiple services.

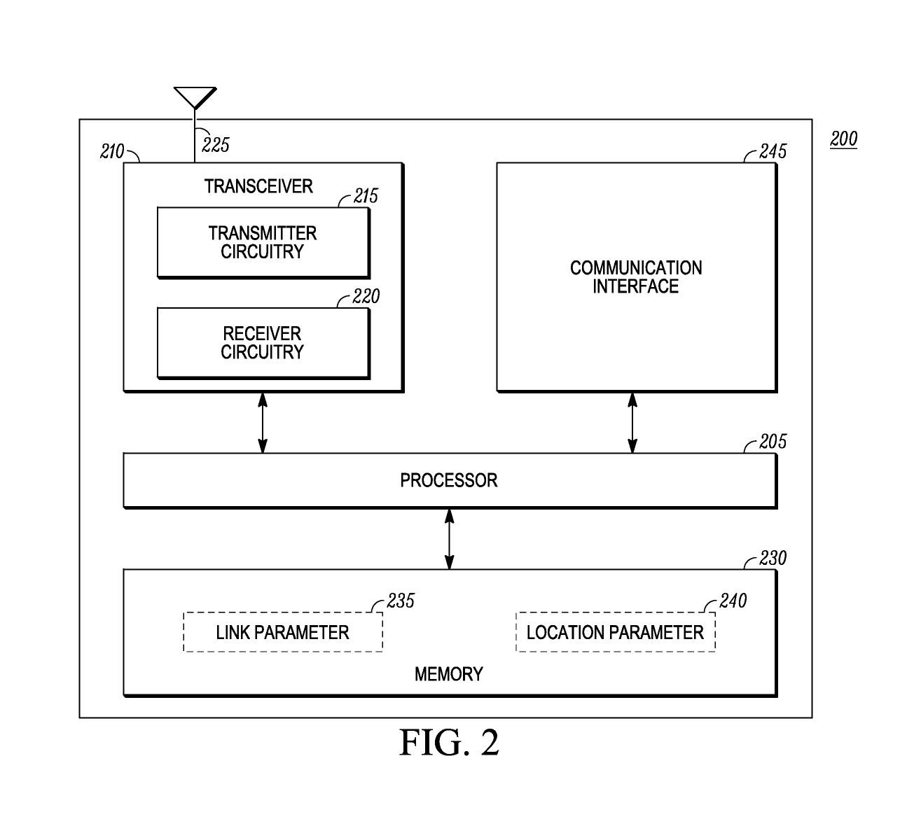

FIG. 2 is a block diagram of a communication device 200 illustrating the internal components according to one embodiment. The communication device 200 can be one of the RAN controller 130 or the group call server 140 in the communication system 100. In one embodiment, the communication device 200 can be the eNodeB 115, 125. The communication device 200 includes a processor 205, a transceiver 210 including a transmitter circuitry 215 and a receiver circuitry 220, an antenna 225, a memory 230 for storing operating instructions that are executed by the processor 205, and a communication interface 245. Although not shown, the communication device 200 also can include an antenna switch, duplexer, circulator, or other highly isolative means (not shown) for intermittently providing radio signals from the transmitter circuitry 215 to the antenna 225 and from the antenna 225 to the receiver circuitry 220. The communication device 200 is an integrated unit containing at least all the elements depicted in FIG. 2, as well as any other elements necessary for the communication device 200 to perform its particular electronic function. Alternatively, the communication device 200 can comprise a collection of appropriately interconnected units or devices, wherein such units or devices perform functions that are equivalent to the functions performed by the elements of the communication device 200.

The processor 205 includes one or more microprocessors, microcontrollers, DSPs (digital signal processors), state machines, logic circuitry, or any other device or devices that process information based on operational or programming instructions. Such operational or programming instructions are stored in the memory 230. The memory 230 can be an IC (integrated circuit) memory chip containing any form of RAM (random-access memory) or ROM (read-only memory), a floppy disk, a CD-ROM (compact disk read-only memory), a hard disk drive, a DVD (digital video disc), a flash memory card, external subscriber identity module (SIM) card or any other medium for storing digital information. One of ordinary skill in the art will recognize that when the processor 205 has one or more of its functions performed by a state machine or logic circuitry, the memory 230 containing the corresponding operational instructions can be embedded within the state machine or logic circuitry. The operations performed by the processor 205 and the other elements of the communication device 200 are described in detail below.

The transmitter circuitry 215 and the receiver circuitry 220 enable the communication device 200 to communicate radio signals to and acquire signals from the eNodeBs 115 and 125. In one embodiment, the transmitter circuitry 215 and the receiver circuitry 220 enable the communication device 200 to communicate radio signals to and acquire signals from the UEs 112-1, 112-2 . . . 112-n, 122-1, 122-2 . . . 122-n. In this regard, the transmitter circuitry 215 and the receiver circuitry 220 include appropriate, conventional circuitry to enable digital or analog transmissions over a wireless communication channel. The implementations of the transmitter circuitry 215 and the receiver circuitry 220 depend on the implementation of the communication device 200. For example, the transmitter circuitry 215 and the receiver circuitry 220 can be implemented as an appropriate wireless modem, or as conventional transmitting and receiving components of two-way wireless communication devices. In the event that the transmitter circuitry 215 and the receiver circuitry 220 are implemented as a wireless modem, the modem can be internal to the communication device 200 or insertable into the communication device 200 (e.g., embodied in a wireless radio frequency (RF) modem implemented on a Personal Computer Memory Card International Association (PCMCIA) card or a universal serial bus (USB) card). For a wireless communication device, the transmitter circuitry 215 and the receiver circuitry 220 are implemented as part of the wireless device hardware and software architecture in accordance with known techniques. One of ordinary skill in the art will recognize that most, if not all, of the functions of the transmitter circuitry 215 and/or the receiver circuitry 220 can be implemented in a processor, such as the processor 205. However, the processor 205, the transmitter circuitry 215, and the receiver circuitry 220 have been artificially partitioned herein to facilitate a better understanding.

The receiver circuitry 220 is capable of receiving radio frequency (RF) signals from at least one frequency band and optionally multiple frequency bands, when, for example, the communications with a proximate device are in a frequency band other than that of the system communications. The transceiver 210 includes one set of transmitter circuitry 215. The antenna 225 comprises any known or developed structure for radiating and receiving electromagnetic energy in the frequency range containing the wireless carrier frequencies. The communication interface 245 uses transceiver 210 to enable the communication device 200 to communicate with other devices and/or systems. For example, the communication interface 245 may include mechanisms for communicating with another device or system via a back bone network 150 as shown in FIG. 1.

As illustrated in FIG. 2, the memory 230 stores link parameter 235 and location parameter 240 associated with a plurality of communication devices or user equipments (UEs) 112-1, 112-2 . . . 112-n, 122-1, 122-2 . . . 122-n participating in the group call. The link parameter 235 includes at least one of received signal strength indication (RSSI) value, carrier to interference ratio plus noise ratio (CINR), traffic on the unicast communication links, and mode of operation associated with each of the plurality of UEs 112-1, 112-2 . . . 112-n, 122-1, 122-2 . . . 122-n participating in the group call. In one embodiment, for the LTE/EUTRA communication system 100, as shown in FIG. 1, the link parameters include a reference signal received power (RSRP) and a reference signal received quality (RSRQ) associated with each of the plurality of UEs 112-1, 112-2 . . . 112-n, 122-1, 122-2 . . . 122-n participating in the group call. The location parameter 240 includes a geographical location of the UEs 112-1, 112-2 . . . 112-n, 122-1, 122-2 . . . 122-n. The communication device 200 uses the link parameter 235 and the location parameter 240 for identifying a group of UEs from the plurality of UEs 112-1, 112-2 . . . 112-n, 122-1, 122-2 . . . 122-n participating in the group call.

In one embodiment, the UEs 112-1, 112-2 . . . 112-n, 122-1, 122-2 . . . 122-n, having a link parameter value or a location parameter value within a predefined range, are grouped together. The link parameter 235 and location parameter 240 are periodically received from all the UEs 112-1, 112-2 . . . 112-n, 122-1, 122-2 . . . 122-n participating in the group call. The communication device 200 receives the link parameter 235 and the location parameter 240 from the UEs through the transceiver circuitry 210 and the uplink channels 137-1 and 137-2, 116-1 . . . 116-n, and 126-1 . . . 126-n. In one embodiment, the communication device 200 also receives link and location parameters from communication devices other than the UEs 112-1, 112-2 . . . 112-n, 122-1, 122-2 . . . 122-n in the communication system 100. The communication devices can be wired or wireless devices. The communication device 200 receives the parameters from the wired communication devices through the communication interface 245.

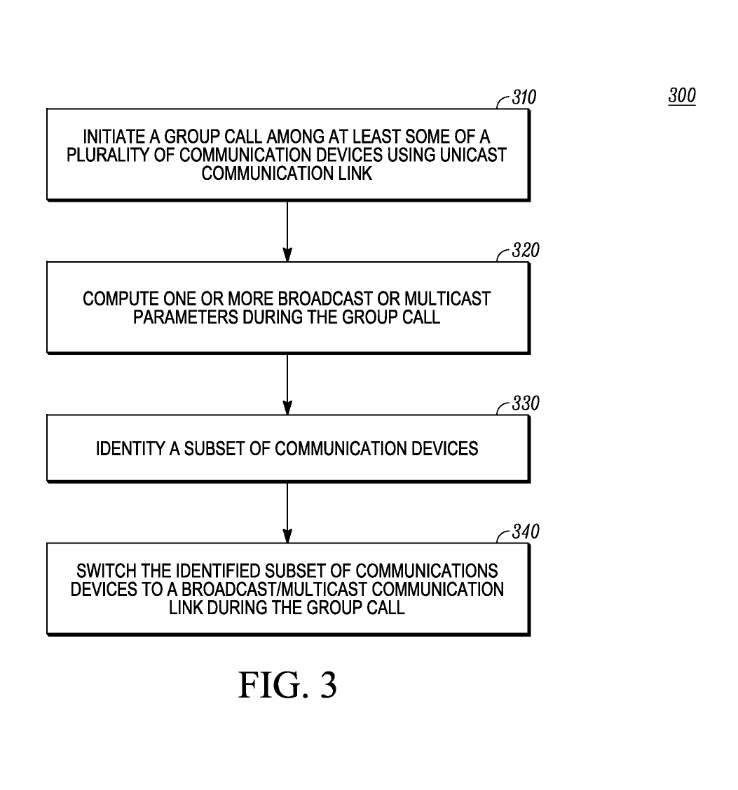

FIG. 3 is a high level flow diagram of a method 300 performed by a control entity, for example, the RAN controller 130, for establishing a group call among a plurality of communication devices in a communication system in accordance with some embodiments. In one embodiment the method 300 can be performed by the eNodeB 115, 125. The method 300 includes initiating 310 a group call among at least some of the plurality of communication devices for e.g. the UEs 112-1 . . . 112-n and 122-1 . . . 122-n, whenever a group call request is detected. The group call request can be from one of the UEs 112-1 . . . 112-n and 122-1 . . . 122-n, eNodeBs 115 and 125, the RAN controller 130 or any other device in the communication system 100. Each communication device 112-1, 112-2 . . . 112-n, 122-1, 122-2 . . . 122-n, 115, 125, and 130 uses a unicast communication link comprising an uplink 137-1, 137-1, 116-1 . . . 116-n, 126-1 . . . 126-n and a downlink 135-1, 135-2, 114-1 . . . 114-n, 124-1 . . . 124-n logical channel pair, for participating in the group call. The method 300 further includes computing 320 one or more broadcast or multicast parameters during the group call and identifying 330 a subset of communication devices based on the computed 320 broadcast or multicast parameters. The identified subset is then switched 340 from the unicast communication link to use a broadcast or multicast communication link comprising a plurality of uplink logical channels and a single downlink logical channel, to participate in the group call.

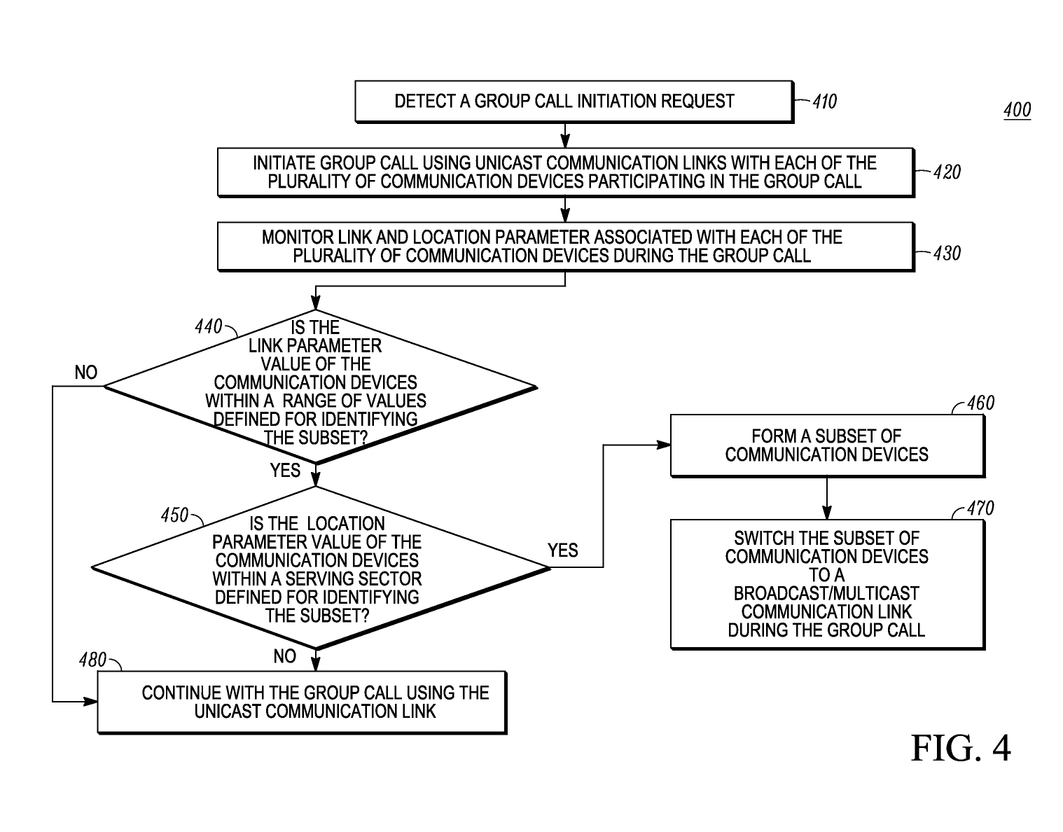

FIG. 4 is a more detailed flow diagram of a method 400 performed by a control entity, for example, the RAN controller 130, for establishing a group call in accordance with some embodiments. In one embodiment the method 400 can be performed by the eNodeB 115, 125. The method includes the RAN controller 130 detecting 410 a group call initiation request from at least one of the plurality of UEs 112-1 . . . 112-n and 122-1 . . . 122-n, the eNodeBs 115 and 125 or any other device in the communication system 100. In one embodiment, the RAN controller 130 initiates the group call. Upon detecting 410 the group call initiation request the RAN controller 130 communicates with the group call server 140 to determine a list of communication devices participating in the group call. The RAN controller 130 then initiates 420 the group call among the communication devices that are member of the group call. The RAN controller 130 sends control instructions to the eNodeBs 115 and 125 to establish unicast communication links with their respective UEs 112-1 . . . 112-n and 122-1 . . . 122-n. A unicast communication link comprises an uplink 116, 126 and a downlink logical channel 114, 124 pair. In one example, the RAN controller 130 sends instructions to the eNodeBs 115 and 125 to establish unicast communication links 116-2-114-2, 116-3-114-3, and 116-n-114-n and 126-1-124-1 and 126-2-124-2 with the UEs 112-2, 112-3, and 112-n and 122-1 and 122-2, respectively, to participate in the group call. In one embodiment, if a particular UE (one of 112-2, 112-3, 112-n, 122-1, and 122-2) is present within a predefined multicast communication region and is already using a multicast communication link, then the RAN controller 130 instructs the eNodeBs 115 and 125 to establish the group call with the particular UE using the multicast communication link.

The method 400 further includes the RAN controller 130 monitoring 430 a set of link and location parameters associated with each of the participating UEs. 112-1, 112-2, 112-3, 112-n, 122-1, and 122-2 during the group call. The monitored link parameters include, but not limited to a received signal strength indication (RSSI) value, a carrier to interference plus noise ratio (CINR) associated with downlink logical channel 114 and data traffic on the unicast communication link (uplink 116, 126 and downlink 114, 124 logical channel pair). The monitored location parameter includes a geographical location such as, latitude, longitude, and altitude, of the participating UEs 112-1, 112-2, 112-3, 112-n, 122-1, and 122-2.

Referring back to the method 400 the RAN controller 130 determines 440 whether the link parameter value for each of the participating UEs (one of 112-1, 112-2, 112-3, 112-n, 122-1, and 122-2) is within a predefined range of values. When the link parameter values associated with the UEs 112-1, 112-2, 112-3, 112-n, 122-1, and 122-2 are within a predefined range, the RAN controller 130 proceeds with determining 450 whether the location parameter value for each of the participating UEs 112-1, 112-2, 112-3, 112-n, 122-1, and 122-2 is within a predefined location range. If the location parameter values associated with the UEs 112-1, 112-2, 112-3, 112-n, 122-1, and 122-2 are within the predefined location range then the UEs are grouped to form 460 a subset for broadcast or multicast communication. The subset can also be called as a dynamically formed MBSFN area or zone 160. On the other hand, if the link parameter values associated with the UEs 112-1, 112-2, 112-3, 112-n, 122-1, and 122-2 are not within a predefined range the UEs 112-1, 112-2, 112-3, 112-n, 122-1, and 122-2 continue 480 the group call using unicast communication links. The communication devices continue with the group call until a group call termination signal is received from any one of the communication devices, for example 112-1, 112-2 . . . 112-n, 122-1, 122-2 . . . 122-n, 115, 125, and 130, participating in the group call.

In one example, a downlink CINR associated with all the UEs 112-1, 112-2, 112-3, 112-n, 122-1, and 122-2 participating in the group call is measured. If the UEs for example 112-1, 112-2, 122-1, and 122-2, as shown in FIG. 1, are found to have the measured downlink CINR value within a range of predefined CINR value, then their geographical location is determined In other words, a check is made whether the UEs 112-1, 112-2, 122-1, and 122-2 have a close physical proximity or the UEs 112-1, 112-2, 122-1, and 122-2 have a geographical location within predefined serving sectors. A serving sector can be defined as a geographical region within a particular cellular site serving the UEs in that part of the cellular site. Returning to the example, the UEs 112-1, 112-2, 122-1, and 122-2 having their CINR value within the predefined range and having a close physical proximity are grouped together to form the subset or MBSFN zone 160. The UEs 112-1, 112-2, 122-1, and 122-2 within the MBSFN zone 160 are switched 470 from unicast communication link to a broadcast or multicast communication link during the group call. The multicast communication link includes a plurality of uplink channels and a single downlink channel. The UEs, for example, 112-3 and 112-n which are participating in the group call and not included in the MBSFN zone 160 continue 480 with the group call using the unicast communication link. On the other hand, if the UEs 112-1, 112-2, 122-1, and 122-2 have their CINR value within the predefined range but are not within a particular geographic location the UEs 112-1, 112-2, 122-1, and 122-2 continue 480 with the group call using the unicast communication links.

For the ease of illustration only a set of UEs are shown to form the subset. However, UEs other than the above mentioned UEs can be a part of the subset. Also, when the UEs move during the group call their association with the subset can change and can lead to the formation of a new subset for multicast communication or a new MBSFN zone. The newly formed MBSFN zone can include the previous set of UEs along with some new UEs or the new MBSFN zone can include a completely different set of UEs.

The method 400 iterates by monitoring 430 periodically the link and location parameters from the UEs participating in the group call and performing the steps of determining 440 through switching 470. In one example, the iteration stops with a group call termination signal from any one of the communication devices 112-1, 112-2 . . . 112-n, 122-1, 122-2 . . . 122-n, 115, 125, and 130 participating in the group call.

In one another embodiment, the RAN controller 130 monitors a spectral efficiency associated with the group call. The spectral efficiency can be determined based on the link parameters associated with the UEs participating in the group call. Based on the spectral efficiency the RAN controller 130 can determine whether to switch the UEs to a broadcast or multicast link or to continue a particular UE with the unicast communication link, during the group call.

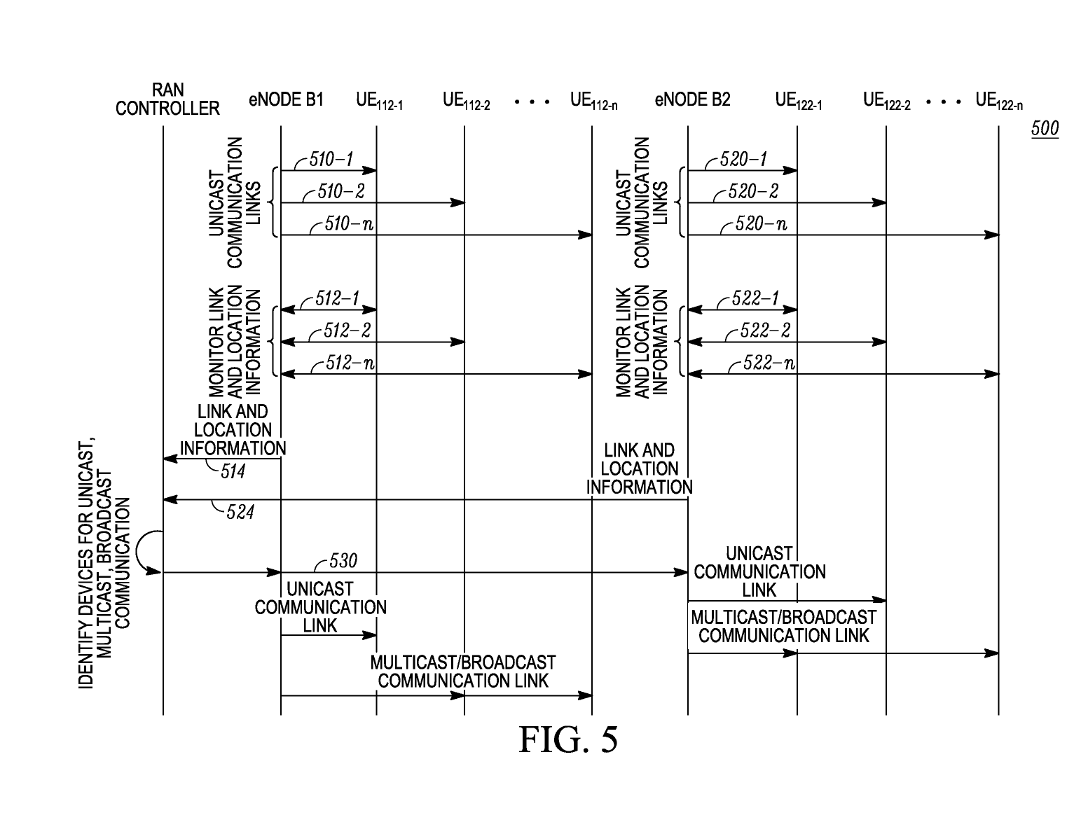

FIG. 5 is a signal flow diagram 500 describing the flow of signals between different devices for establishing a group call in accordance with some embodiments. The signal flow diagram 500 describes the flow of signals between the RAN controller 130, the eNodeBs 115 and 125, and the UEs 112-1 . . . 112-n and 122-1 . . . 122-n. Upon receiving a group call initiation request (not shown) the eNodeB 115, 125 establishes respective unicast communication links 510-1 . . . 510-n, 520-1 . . . 520-n with the UEs 112-1, 112-2 . . . 112-n, 122-1, 122-2 . . . 122-n participating in the group call. Further, the eNodeBs 115 and 125 monitor, by exchanging signals 512-1 . . . 512-n and 522-1 . . . 522-n, link and location parameters associated with their respective UEs 112-1, 112-2, 112-n, 122-1, 122-2, and 122-n, participating in the group call. The eNodeBs 115 and 125 monitor the link and location parameters using the established unicast communication links. The eNodeBs 115 and 125 forward, by sending the signals 514, 524, the link and location parameters to the RAN controller 130.

Upon receiving the link and location parameters from the eNodeBs 115 and 125 the RAN controller 130 identifies UEs for unicast, multicast, and broadcast communication, based on the link and location parameters. The RAN controller 130 then sends control instructions 530 to the eNodeBs 115, 125 to switch at least some of the identified UEs to use a broadcast or multicast communication link. In one example, as illustrated in FIG. 5, the RAN controller 130 sends control instructions 530 to the eNodeBs 115 and 125 to switch the UEs 112-2, 112-n, 122-1, and 122-n to a broadcast or multicast communication link and to continue the UEs 112-1 and 122-2 with the unicast communication link. Upon receiving the control instructions 530, the eNodeBs 115 and 125 switch the respective UEs 112-2 and 112-n and 122-1 and 122-n to a broadcast or multicast communication link to continue with the group call. The eNodeBs 115 and 125 continue the group call with the UEs 112-1 and 122-2, respectively, using unicast communication links.

In one embodiment, when the RAN controller 130 identifies that a particular UE or a group of UEs is serviced by at least two eNodeBs 115 and 125 a simulcast transmission is enabled in the communication system 100. The RAN controller 130 instructs both the eNodeBs 115 and 125 to simulcast transmission to the particular UE or the group of UEs. Simulcast transmission is defined as transmission of same data or information to the particular UE or the group of UEs from all the eNodeBs serving the particular UE or the group of UE at the same frequency and at the same instant of time. In one embodiment, the same data or information is simultaneously transmitted from both the eNodeBs 115 and 125 to the particular UE using a unicast communication link. In another embodiment, the same data or information can be simultaneously broadcast or multicast from both the eNodeBs 115 and 125 to the group of UEs through the broadcast or multicast communication link.

Advantages of the various embodiments include: enabling a faster call setup using unicast communication links and switching to a spectrally efficient multicast communication link during the call. This switching helps in reducing the number of unicast communication links used in the group call thereby effectively increasing the spectral efficiency of the group call. For example, in the prior art method, if twenty five users are participating in the group call, the system has to allocate twenty five unicast communication links or fifty logical frequency channels. With the present method, the system allocates the fifty logical frequency channels, only when the group call is started. During the group call, if all the twenty five users are found to be within a particular geographical area or having a predefined signal range, they will be grouped to form a subset for multicast communication. The multicast communication uses twenty five uplink logical channels and a single downlink logical channel. This reduces the number of logical frequency channels from fifty to twenty six. Thus the present method provides an optimized two step group call setup by starting with a quick unicast call and switching to a more spectrally efficient multicast call. In accordance with some embodiments the switching is also based on the mobility of the communication devices participating in the group call. This provides a dynamically optimized group call setup. Those skilled in the art will realize that the above recognized advantages and other advantages described herein are merely illustrative and are not meant to be a complete rendering of all of the advantages of the various embodiments.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for establishing a group call among a plurality of communication devices in a communication system, wherein the communication system comprises the plurality of communication devices serviced by their respective base stations and a control entity communicating with the base stations, the method comprising:
initiating a group call among at least some of the plurality of communication devices, wherein each communication device uses a unicast communication link to participate in the group call;
computing, at the control entity, one or more broadcast or multicast parameters during the group call;
identifying, at the control entity, a subset of communication devices based on the broadcast or multicast parameters; and
switching, at the control entity, the identified subset of communications devices to a broadcast or multicast communication link during the group call.

2. The method of claim 1 further comprising:
continuing the group call using the unicast communication link with communication devices other than the identified subset of communication devices in the at least some of plurality of communication devices participating in the group call.

3. The method of claim 1, wherein the unicast communication link comprises an uplink and a downlink logical channel pair for establishing one to one communication between the communication device and the base station.

4. The method of claim 1, wherein the broadcast communication link comprises a plurality of uplink logical channels and a single downlink logical channel for establishing many to one communication between the communication devices in the identified group and the base station.

5. The method of claim 1, wherein the broadcast or multicast parameter includes at least one of link parameter and location parameter associated with each of the plurality of communication devices participating in the group call.

6. The method of claim 5, wherein the link parameter includes at least one of carrier to interference plus noise ratio, traffic on the unicast communication links, and mode of operation associated with each of the plurality of communication devices participating in the group call.

7. The method of claim 6 further comprising:
measuring a downlink carrier to interference plus noise ratio value for each of the communication devices participating in the group call; and
grouping the communication devices having a measured downlink carrier to interference plus noise ratio value within a range of predefined carrier to interference plus noise ratio value to form the subset.

8. The method of claim 5, wherein the location parameter includes a geographical location of the communication device.

9. The method of claim 8 further comprising:
grouping the communication devices having a geographical location within predefined serving sectors to form the subset.

10. The method of claim 1 further comprising:
monitoring a spectral efficiency associated with the group call; and
switching at least a part of the plurality of communication devices participating in the group call to at least one of unicast, multicast, and a broadcast communication link based on the spectral efficiency, during the call.

11. The method of claim 1 further comprising:
receiving a group call initiation request from at least one of the plurality of communication devices prior to initiating the group call using unicast communication links.

12. The method of claim 1 further comprising:
determining whether at least one communication device in the identified subset is capable of being serviced by at least two base stations; and
enabling the at least two base stations to simulcast transmission to the at least one communication device using the multicast communication link.

13. The method of claim 1 further comprising:
determining whether at least one communication device in the identified subset is capable of being serviced by at least two base stations; and
enabling the at least two base stations to simulcast transmission to the at least one communication device using the unicast communication link.

14. An apparatus comprising:
a communication interface for receiving a group call initiation request form at least one of a plurality of communication devices participating in the group call;
a processor coupled to the communication interface, wherein the processor is configured to:
initiate a group call among at least some of the plurality of communication devices, wherein each communication device uses a unicast communication link to participate in the group call;
compute, one or more broadcast or multicast parameters during the group call;
identify a subset of communication devices based on the broadcast or multicast parameters; and
switch the identified subset of communications devices to a broadcast or multicast communication link during the group call.

15. The apparatus of claim 14, wherein the processor is further configured to:
continue the group call using the unicast communication link with communication devices other than the identified subset of communication devices in the at least some of plurality of communication devices participating in the group call.

16. A system for establishing a group call, the system comprising:
a plurality of communication devices serviced by their respective base stations, wherein at least some of the plurality of communication devices participate in the group call using unicast communication links; and
a control entity for communicating with the base stations, wherein the control entity
computes one or more broadcast or multicast parameters during the group call;
identifies a subset of communication devices based on the broadcast or multicast parameters; and
switches the identified subset of communications devices to a broadcast or multicast communication link during the group call.

17. The system of claim 16, wherein the control entity enables the communication devices other than the identified subset of communication devices in the at least some of the plurality of communication devices participating in the group call to continue with the group call using the unicast communication link.
